(19) United States
(12) Patent Application Publication
(10) Pub. No.: US 2007/0234340 A1
(43) Pub. Date: Oct. 4, 2007

(54) Valve calibration routine

(76) Inventors: Richard P. Strosser, Akron, PA (US); Christopher A. Foster, Akron, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/711,589

(22) Filed: Feb. 27, 2007

Related U.S. Application Data
(60) Provisional application No. 60/777,180, filed on Feb. 27, 2006.

(51) Int. Cl. G06F 9/44

(52) U.S. Cl. 717/173

(57) ABSTRACT

A method for calibrating a proportional solenoid valve used in the propulsion system of a windrower, wherein a programmable control module in connection with a valve and a sensor is programmed as part of an automatic calibration routine for directing test control signals to the valve for causing a predetermined displacement of the hydraulic cylinder, the test control signals having values which vary based on the actual displacement of the hydraulic cylinder as compared with a predetermined value of displacement, and operating the hydraulic cylinder using the test control signal that causes the predetermined displacement of the element. The predetermined displacements correspond to the crack points, or the electrical signal levels at which two ports of interest are just beginning to open to one another from a closed position. Of particular interest are the crack points from the supply pressure port to each of the work ports and from the tank port to each of the work ports.

This application claims the benefit of U.S. Provisional Application No. 60/777,180, filed Feb. 27, 2006.

### TECHNICAL FIELD

The present invention relates to equipment calibration and, more particularly, to a method embodied in a computer program for calibration of a valve, more particularly to calibration of a proportional solenoid valve, and even more particularly to calibration of a proportional solenoid valve used in the propulsion system of an agricultural windrower.

### BACKGROUND OF THE INVENTION

U.S. Pat. No. 6,901,729, is incorporated herein by reference in its entirety. This patent describes a windrower. While other embodiments are possible, it is this general type of windrower that provides the best example of the type of system with which the apparatus and method of the instant invention can/should be used. U.S. Provisional Application No. 60/777,180, filed Feb. 27, 2006, is also incorporated herein by reference in its entirety.

In any modern windrower, and much other similar equipment, proportional solenoid controlled valves, activated by electrical currents, are used to control hydraulic devices such as cylinders in the actuation of various systems including the propulsion system. Associated with these valves is a range of current values that causes movement of a movable element of the valve such as a spool or barrel, without creating a path for hydraulic fluid flow between ports. The current value required to move the valve sufficiently to allow fluid communication between ports is referred to as an offset value. An offset of particular interest is the input current required to move the valve to a point in which hydraulic fluid first begins to flow.

It is important to efficient and effective operation of the system to calibrate the valve based on the offset values required to directly activate a proportional valve using electrical current. These offset values can determine the “crack” points between various ports. The “crack” points are the electrical signal levels at which two ports of interest are just beginning to open to one another from a closed position. Of particular interest are the crack points from the supply pressure port to each of the work ports and from the tank port to each of the work ports.

Therefore, it would be desirable to have a method which enables calibration of a valve based on the electrical current offset required to determine the crack points, for instance, those from the supply port to each of the working ports and from the tank port to each of the working ports.

### SUMMARY OF THE DISCLOSURE

What is disclosed is an apparatus and method which enables calibration of a proportional solenoid valve activated by electrical current, by determining the crack points from the supply port to the working ports and from the tank port to each of the working ports by automatically deriving the electrical current offsets associated with these crack points.

According to a preferred aspect of the invention, the method utilizes a programmable control module in connection with at least one proportional solenoid valve and a sensor for detection of hydraulic cylinder displacement. The displacement of the moveable element of the hydraulic cylinder is variably controllable as a function of the electrical current signals. The electrical current signals are varied based on an actual displacement of the moveable element of the hydraulic cylinder as compared to a predetermined displacement corresponding to the initial electrical current signal. The current value associated with the offsets can be found by applying levels of input current to the valve and monitoring the hydraulic cylinder for initiation of movement as an indication of fluid flow.

A control module is programmed as part of an automatic calibration routine for directing control signals to the signal controlled device and receiving sensor inputs representative of an actual displacement of the hydraulic cylinders. The solenoid controlling the valve receives test control signals having values which will vary based the actual displacement of the hydraulic cylinder as compared to a predetermined displacement.

According to a preferred aspect of the invention, the signals comprise electrical current values within a range anticipated to encompass the current values required for the displacement of the hydraulic cylinder through its range of displacements. Additionally the sensor provides information representative of displacement of the hydraulic cylinder.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a side elevational view of a crop harvesting machine of the type with which the invention may be used;

FIG. 2 includes a diagram, schematic and a representative relationship between flow rate and input current for a valve of the type with which the invention may be used;

FIG. 3 is a top level block diagram including the interconnections of the invention;

FIG. 4 is a high level flow diagram of steps of a preferred embodiment of a computer program of the invention;

FIG. 5 is another high-level flow diagram of steps of a preferred embodiment of a computer program of the invention;

FIG. 6 is another high-level flow diagram of steps of a preferred embodiment of a computer program of the invention;

FIG. 7 is another high-level flow diagram of steps of a preferred embodiment of a computer program of the invention;

FIG. 8 is a written listing of steps of the preferred program of the invention;

FIG. 9 is a written listing of still further steps of the preferred program of the invention; and

FIG. 10 is a written listing of still further steps of the preferred program of the invention;

FIG. 11 is a written listing of still further steps of the preferred program of the invention;

FIG. 12 is a written listing of still further steps of the preferred program of the invention;

FIG. 13 is a written listing of still further steps of the preferred program of the invention;

FIG. 14 is a written listing of still further steps of the preferred program of the invention;

FIG. 15 is a written listing of still further steps of the preferred program of the invention;

FIG. 16 is a written listing of still further steps of the preferred program of the invention;

FIG. 17 is a written listing of still further steps of the preferred program of the invention;

FIG. 18 is a written listing of still further steps of the preferred program of the invention;

FIG. 19 is a written listing of still further steps of the preferred program of the invention;

FIG. 20 is a written listing of still further steps of the preferred program of the invention;

FIG. 21 is a written listing of still further steps of the preferred program of the invention;

FIG. 22 is a written listing of still further steps of the preferred program of the invention;

FIG. 23 is a written listing of still further steps of the preferred program of the invention;

FIG. 24 is a written listing of still further steps of the preferred program of the invention;

FIG. 25 is a written listing of still further steps of the preferred program of the invention;

FIG. 26 is a written listing of still further steps of the preferred program of the invention;

FIG. 27 is a written listing of still further steps of the preferred program of the invention;

FIG. 28 is a written listing of still further steps of the preferred program of the invention;

FIG. 29 is a written listing of still further steps of the preferred program of the invention;

FIG. 30 is a written listing of still further steps of the preferred program of the invention;

FIG. 31 is a written listing of still further steps of the preferred program of the invention;

FIG. 32 is a written listing of still further steps of the preferred program of the invention;

FIG. 33 is a written listing of still further steps of the preferred program of the invention;

FIG. 34 is a written listing of still further steps of the preferred program of the invention;

FIG. 35 is a written listing of still further steps of the preferred program of the invention;

FIG. 36 is a written listing of still further steps of the preferred program of the invention;

FIG. 37 is a written listing of still further steps of the preferred program of the invention;

FIG. 38 is a written listing of still further steps of the preferred program of the invention; and

FIG. 39 is a written listing of still further steps of the preferred program of the invention.

### DETAILED DESCRIPTION OF THE PREFERRED EMBODIMENTS

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” is used as a matter of mere convenience, and is determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

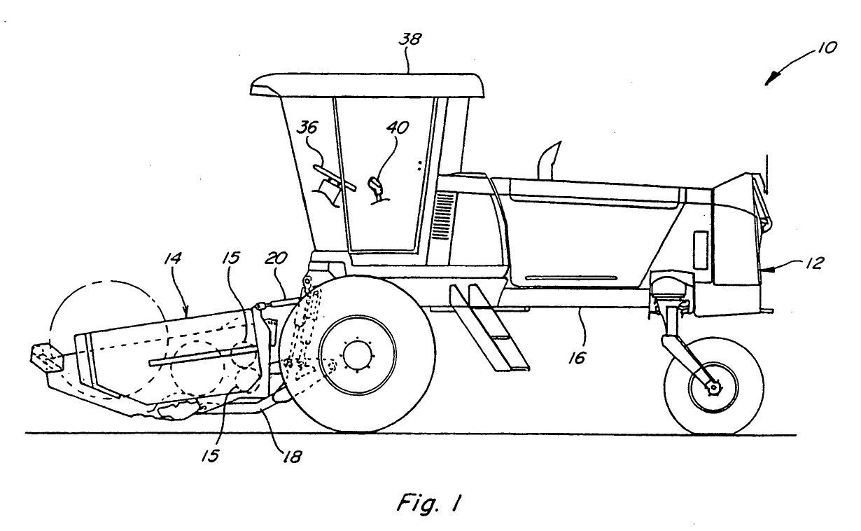

FIG. 1 shows the present invention utilized in connection with a self-propelled windrower 10; however, it will be appreciated that the principles of the present invention are not limited to a self-propelled windrower, or to any specific type of harvesting machine.

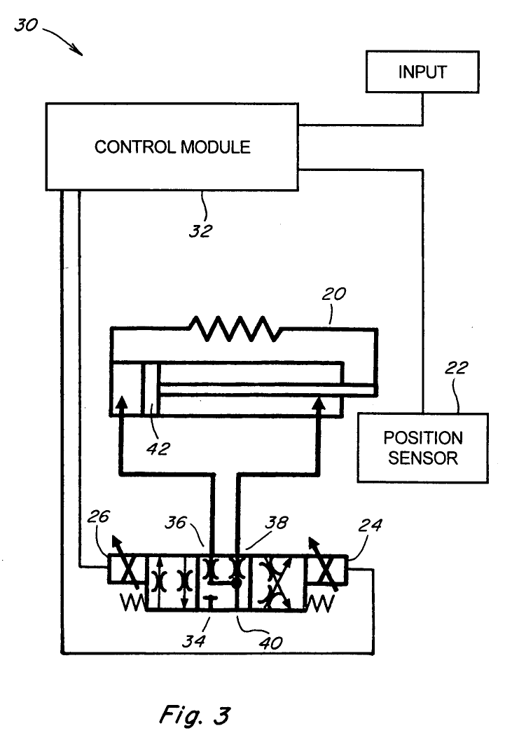

In the illustrated embodiment, the self-propelled windrower 10 comprises a tractor 12 and a header 14 attached to the front end of a frame 18 or chassis of the tractor 12. FIG. 3 shows a top level block diagram 30 of the interconnections of exemplary valve apparatus that can be calibrated using the method embodied in the invention. The method of the present invention describes a routine programmed in a control module 32 that calibrates the input current offsets of a proportional solenoid valve controlled hydraulic actuator as represented by hydraulic actuator 20 which is a common hydraulic cylinder. Application of the input current offsets to a solenoid 24, 26 causes movement in the valve to the point at which two ports are just beginning to open to one another. This offset current can be identified by monitoring a motion or displacement of a moveable element 42 of the actuator 20, which can be, for instance, a piston and rod assembly. A sensor 22 is used to sense cylinder 42 motion and/or position, embodied by motion or displacement of element 42. The offset values to be sensed can be, but are not necessarily limited to:
1. The ‘cracking’ of a supply pressure port (P) 34 to each of the work ports 36, 38.
2. The ‘cracking’ of a tank port (T) 40 to each of the work ports 36, 38.

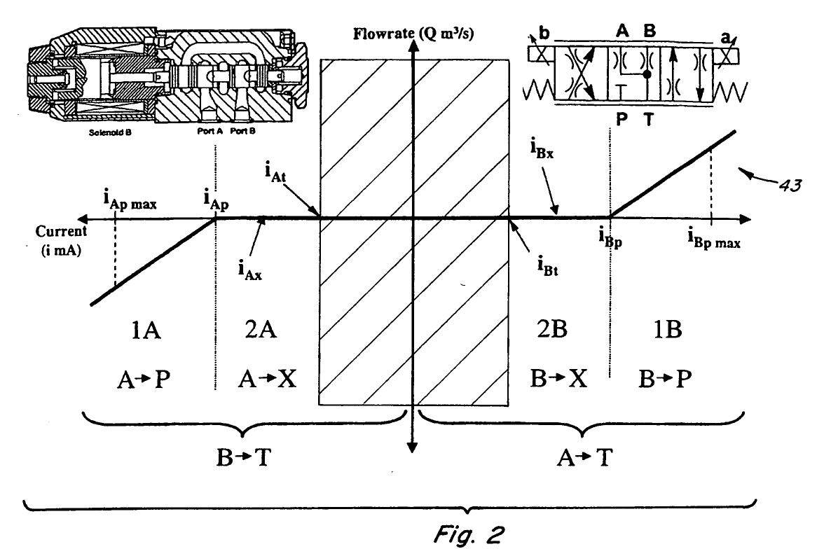

The ‘crack’ points are defined as the electrical signal levels at which two ports 34, 36, 38, 40 of interest are just beginning to open to one another from a closed position. The profile 43 of the ‘crack’ points in relation to hydraulic fluid flow and current applied to solenoid 24, 26 is shown in FIG. 2. Points iAp, iAt, iBp, and iBt can be defined as crack points. A crack point is detected via motion of actuator 20 which is directly correlated to flow. To calibrate a ‘cracking’ point, a binary divide algorithm is used.

The binary divide routine uses a set of predetermined parameters. These parameters must be defined before execution of the algorithm. These parameters are:
1. Upper limit of electrical signal value (i_ul).
2. Lower limit of electrical signal value (i_ll).
3. Nominal value of electrical signal (i_nom).
4. Dwell time 1 (dt1).
5. Dwell time 2 (dt2).
6. A predetermined distance of cylinder motion (dp).
7. Tolerance on predetermined distance of cylinder motion (dp_tol).
8. Value of electrical signal to be held between stages of calibration (i_null).
9. Number of loops through calibration (n_loops). Other variables used in the algorithm are:
10. High signal history value (i_hh).
11. Low signal history value (i_hl).
12. Electrical test signal value (i_test).
13. initial cylinder position (p_i).
14. Final cylinder position (p_f).
15. Cylinder position difference (dp_diff).
16. Loop counter (count).
17. Number of time cylinder moved (num_mv).
18. Number of times cylinder didn't move (num_nomv).

Noted below is the step by step procedure involved in running a calibration for a single crack point:

### Initialization of Binary Divide Algorithm:

Step 1: Set Electrical test signal to nominal value, i_test=i_nom.
Step 2: Set high history value to upper limit of electrical signal value, i_hh=i_ul.
Step 3: Set low history value to lower limit of electrical value, i_hl=i_ll.
Step 4: Set counters to zero, Count=num_mv=num_nomv=0.

### Binary Divide Algorithm:

Step 1: Check position of cylinder by averaging sensor value over dt1. Set p_i to this value.
Step 2: Set hardware to the test value, i_test, and hold for dt2.
Step 3: While maintaining electrical signal at i_test, check cylinder position by averaging sensor value over dt1. Set p_f to this value. Set i_test to i_null.
Step 4: Check distance of cylinder motion d by comparing p_i and p_f.
Step 5: Did cylinder move?
   If cylinder moved greater than dp, increment num_mv counter. num_mv=num_v+1.
   If cylinder moved less than dp, increment num_nomv counter. num_nomv=num_nomv+1.
   Increment loop counter, count=count+1.
   If loop counter (count) is greater than limit (n_loops), prepare to exit algorithm.
   If either num_mv or num_nomv is equal to zero (cylinder either always moved or never moved),

Calibration Failed.
Otherwise record and/or return value of i_test and exit algorithm.

Calibration Complete.
Step 6: Determine new value of i_test.
   If distance of cylinder motion greater than dp, set next electrical test signal value to: i_test=i_test+(i_hh−i_test)/2.
   If distance of cylinder motion greater than dp, set next electrical test signal value to: i_test=i_test−(i_test−i_hl)/2.
Step 7: Check to see if new i_test values are out of bounds.
   If i_test>i_ul or i_test<i_ll, then set warning flag and exit calibration.

Calibration Failed.
Step 8: Return to Step 2.

This algorithm is run for each of the defined calibration points. For example the crack points iAp, iAt, iBp, and iBt shown in FIG. 3, the binary divide routine would be run a total of four times. Each of the values 1-8 noted above would have to be redefined for each of the four runs. For the crack to tank calibrations, an external force would have to be applied to the cylinder to force oil flow from the hydraulic cylinder through the valve. One way of doing this is to use a spring centered cylinder and set the cylinder to a position away from the spring centered position at the beginning of the test.

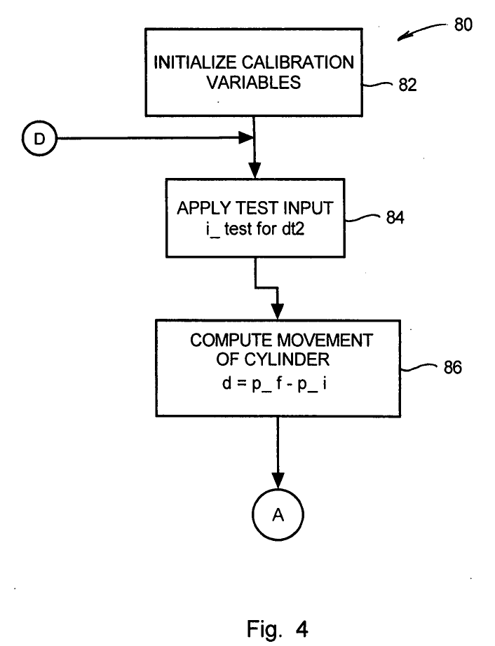

Referring also to FIGS. 4-7, a flow diagram 80 illustrating steps of a method of the instant invention for determining the offset values for control of a proportional solenoid valve operable for controlling movement of element 42 of hydraulic cylinder 20 is shown. The steps of flow diagram 80 are preferably programmed in, and executable by, control module 32 at appropriate times, such as, but not limited to, when changes in the hydraulic system are effected. The calibration routine will be initiated and automatically run in such situations. As shown in FIG. 4, block 82 initiates an offset calibration routine. The variables referenced above are initialized at block 82. At block 84 a current input i_test is applied for a specified duration dt2. The actual responsive movement d of hydraulic cylinder element 42 is computed at block 86 as the final position p_f of cylinder 42 minus the initial position p_i of cylinder 42.

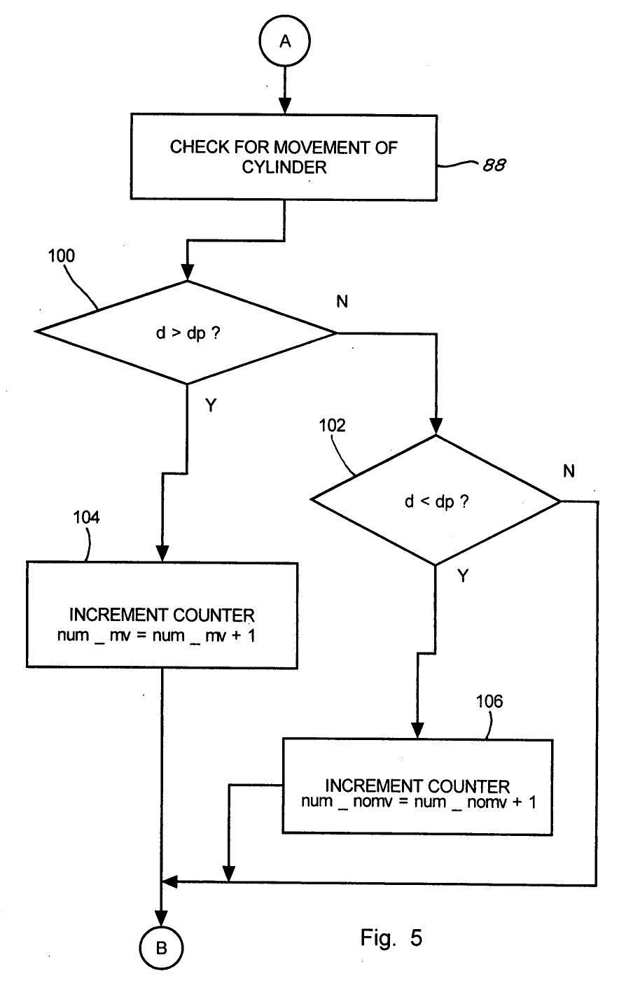

Following bubble A to FIG. 5 module 32 checks for cylinder 42 movement at block 88. Actual displacement d is compared to a predetermined displacement expected dp in response to the initial input i_test in the step shown in decision blocks 100, 102. If actual displacement d of cylinder 42 exceeds predetermined displacement expected dp in response to the initial input i_test, a counter indicating cylinder element 42 movement, num_mv is incremented at block 104. If actual displacement d of cylinder 42 is less than predetermined displacement expected dp in response to the initial input i_test, a counter indicating a lack of cylinder element 42 movement, num_nomv is incremented at block 106.

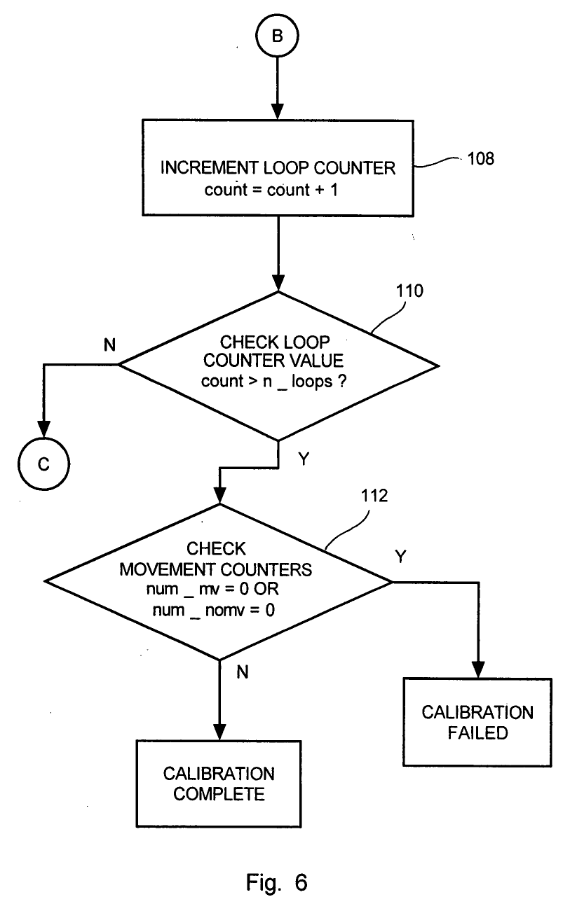

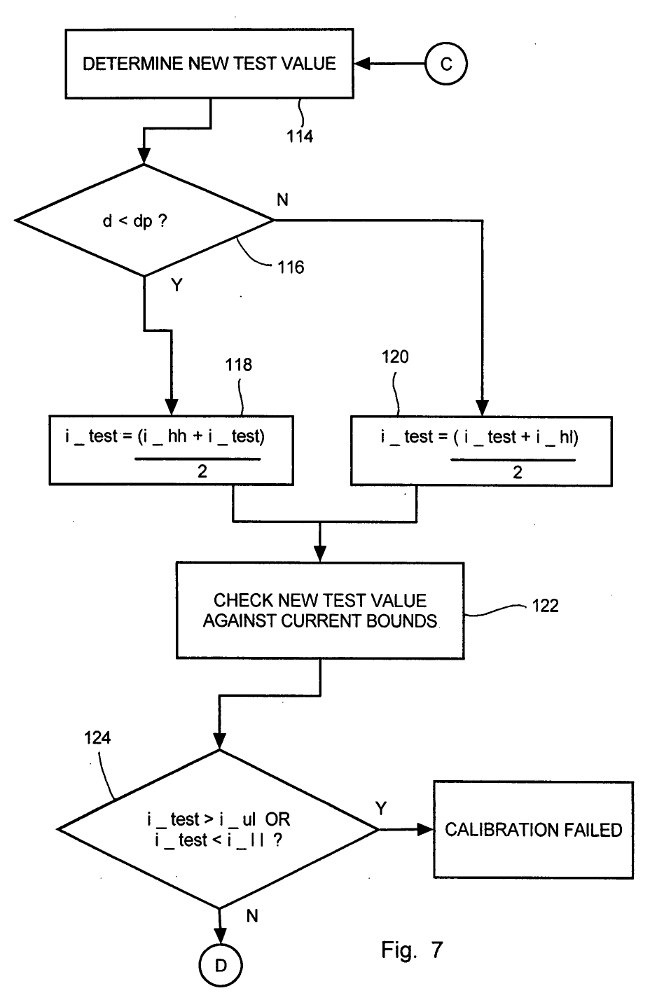

Following bubble B, a loop counter count is incremented at block 108 as shown in FIG. 6. Count is compared to a predetermined number of times n_loops as shown at block 110. If count has reached n_loops, module 32 compares counters num_mv and num_nomv to zero at decision block 112. If either num_mv or num_nomv are zero, cylinder 42 either moved for every value of i_test or for no value of i_test. Module 32 reports a calibration failure. If num_mv and num_nomv are nonzero, calibration is complete and the value of i_test is noted or stored by module 32. If count has not reached n_loops, a new value of i_test is calculated by following bubble C to FIG. 7 which represents additional steps of module 32.

In FIG. 7 a new value of i_test is calculated as shown at block 114. Decision block 116 compares actual displacement d to predetermined displacement dp. If actual displacement d is less than predetermined displacement dp, i_test is calculated to be a value half way between a previously set high history i_hh value of i_test according to a binary divide algorithm as indicated in block 118. If actual displacement d is not less than predetermined displacement dp, i_test is calculated to be a value half way between a previously set low history i_hl value of i_test according to the binary divide algorithm as indicated in block 120. The high history i_hh is initialized to the current upper limit, and updated with the value i_test when actual displacement d is greater than dp. The low history i_hl is initialized to the current lower limit, and updated with the value i_test when actual displacement d is less than dp. Once the new i_test is calculated, its value is checked against the input current upper limit and lower limit. If the new i_test is outside these limits, the calibration fails. If the new i_test is within these limits, module 32 follows bubble D to repeat application of i_test at block 84 of FIG. 4 with the new i_test.

As a result of execution of the calibration routine of the instant invention, registers of control module 32 will contain information representative of input electrical current values required to be directed to solenoid 24, 26 to determine current values corresponding to crack points such as iAp, iBp, iAt, and iBt.

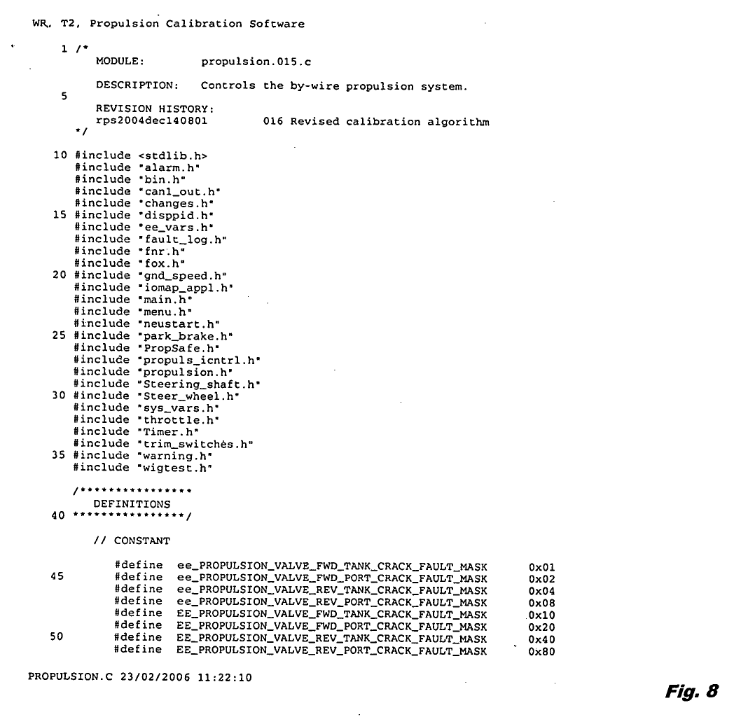

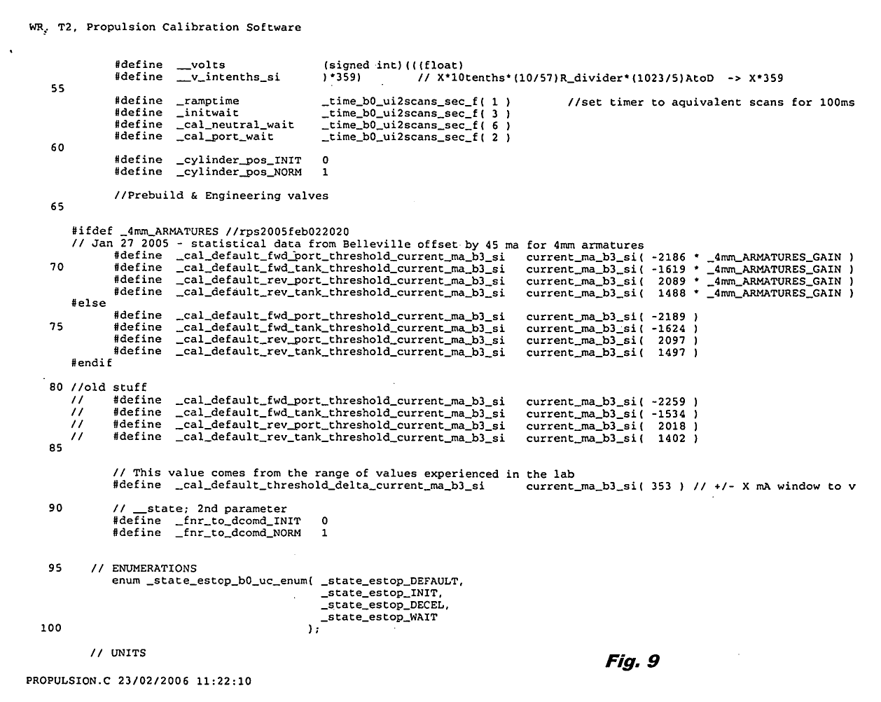

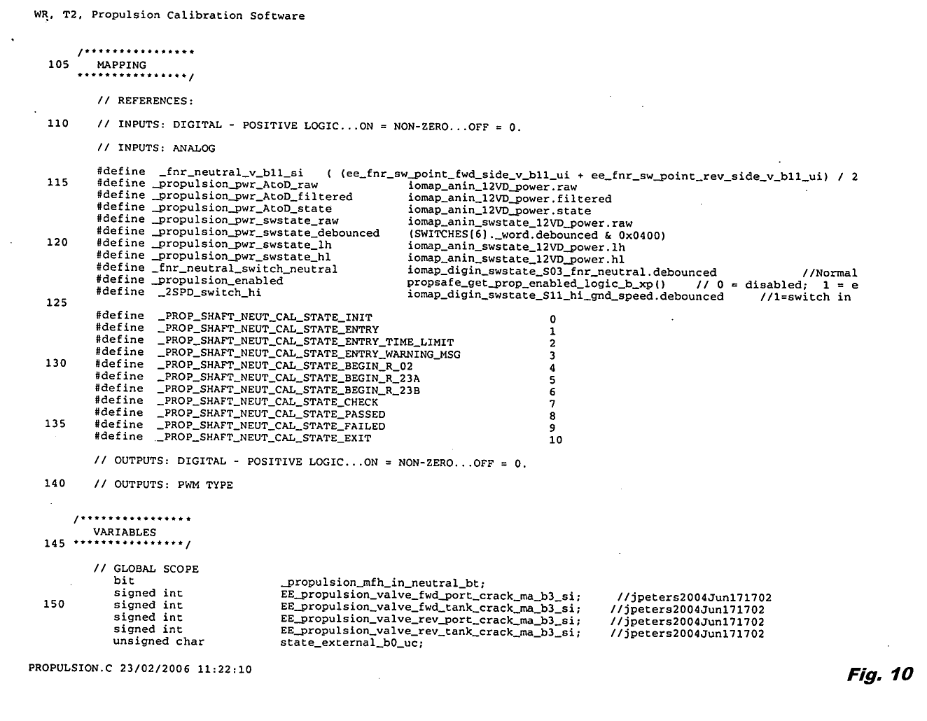

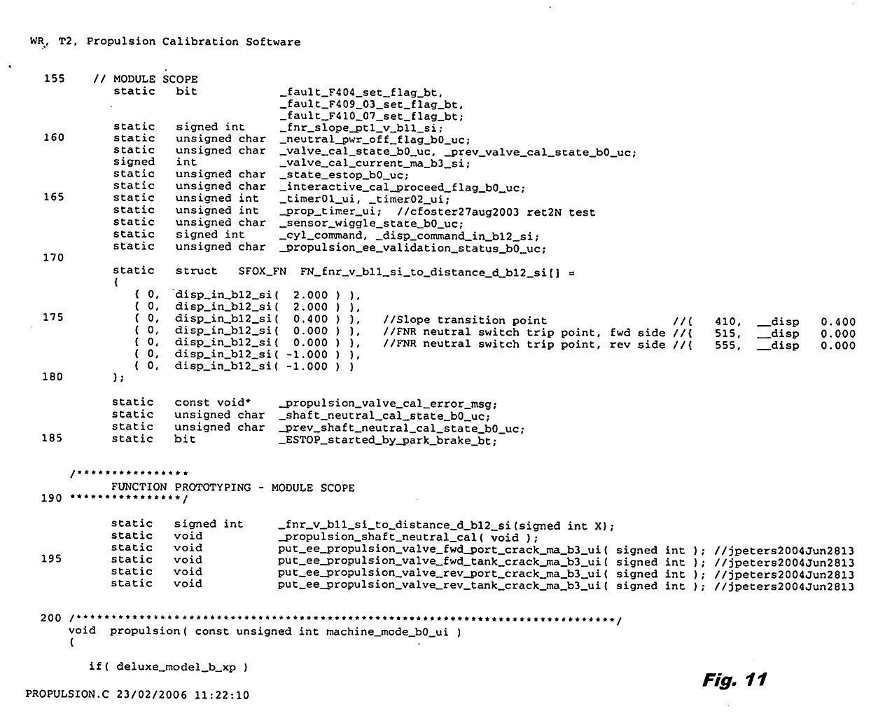

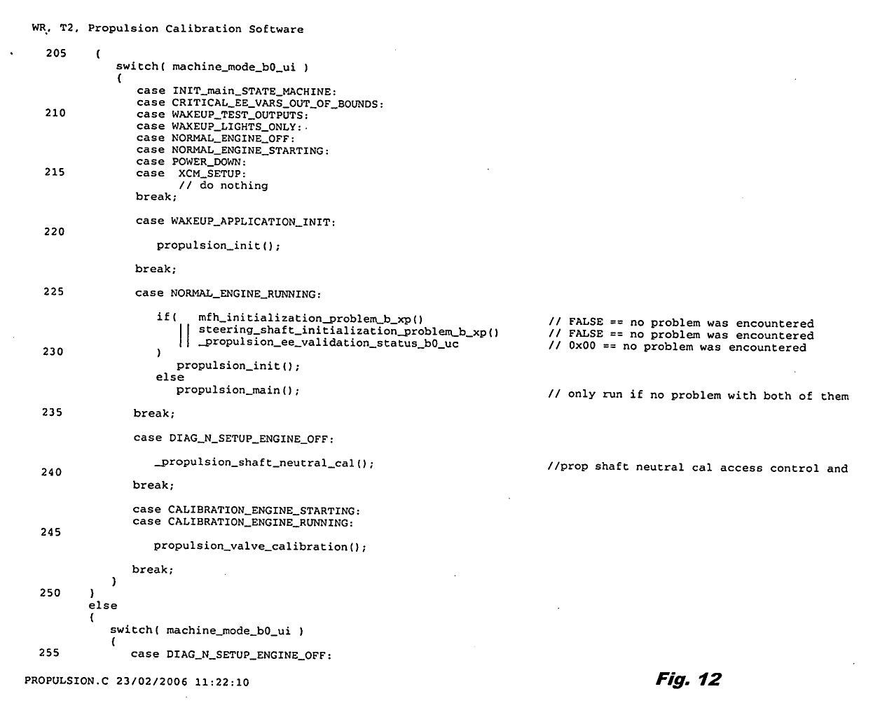

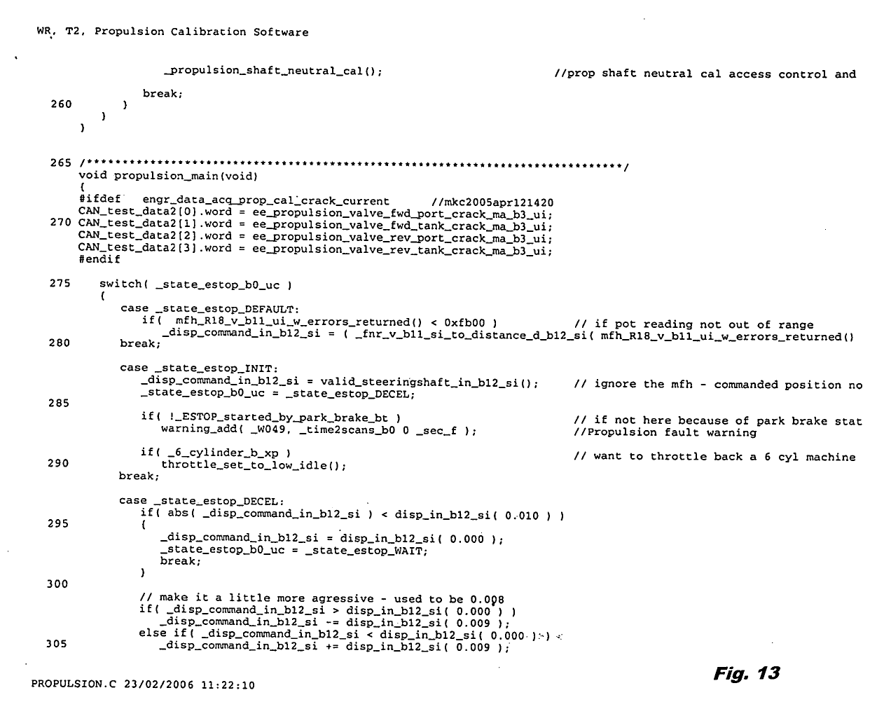

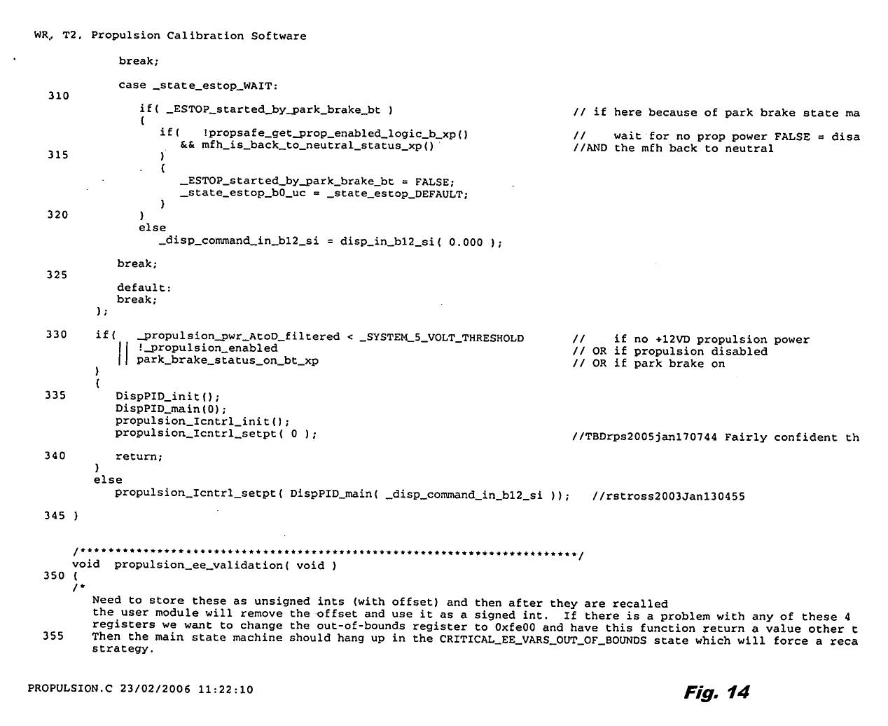

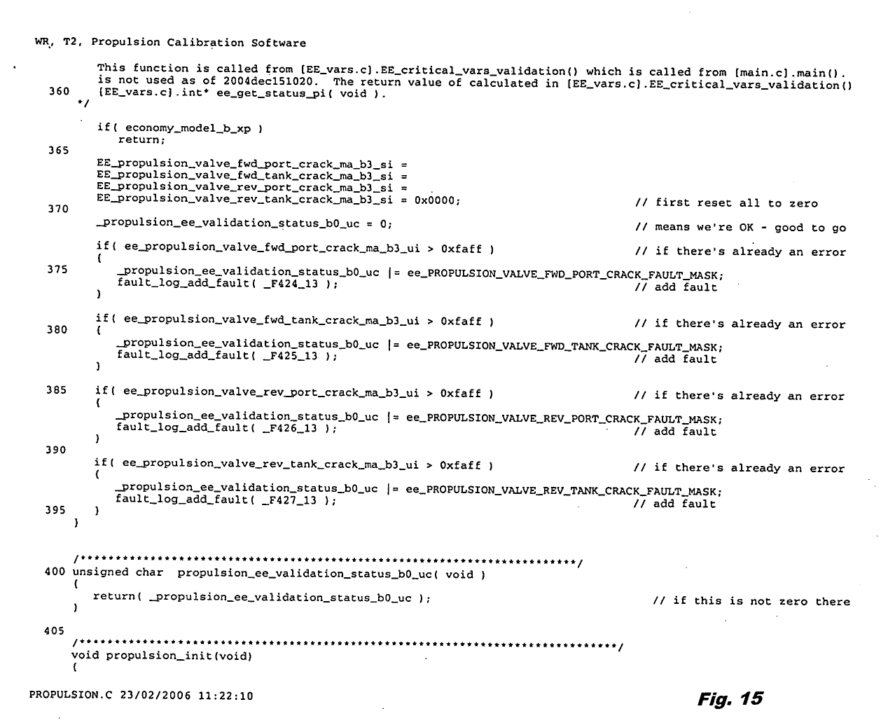

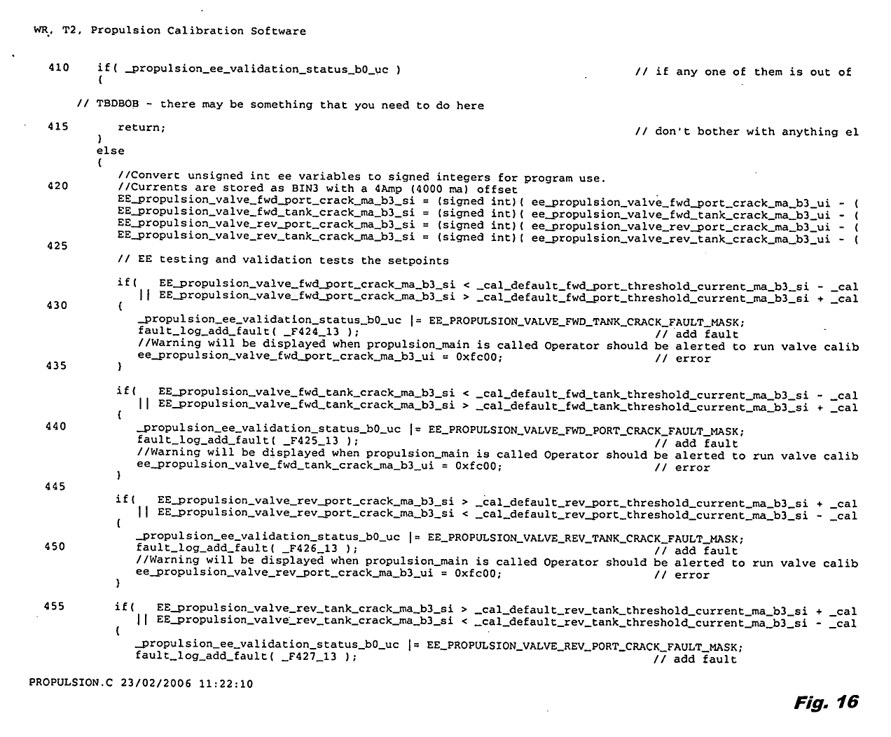

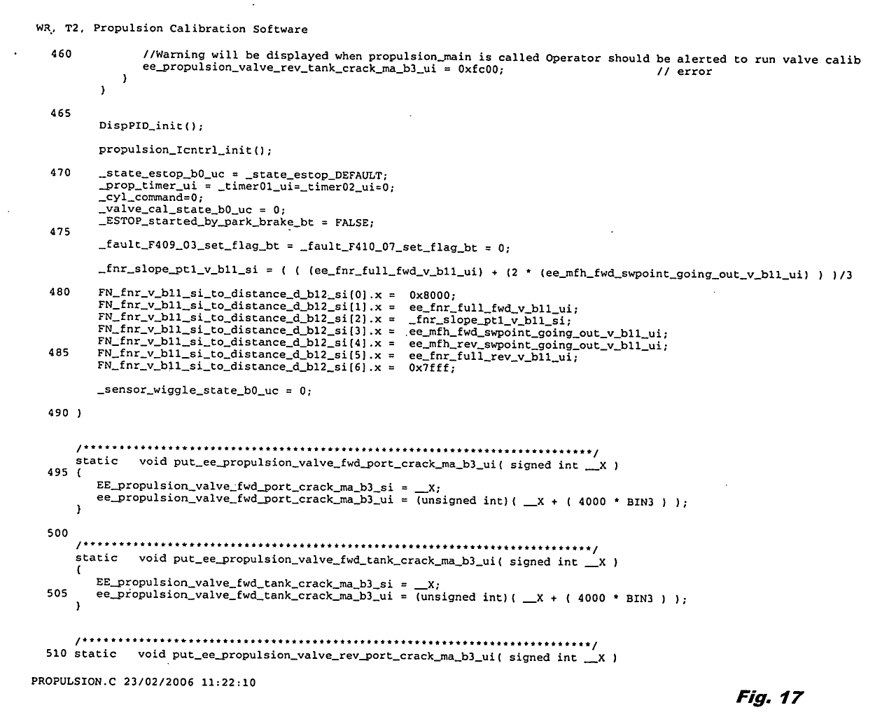

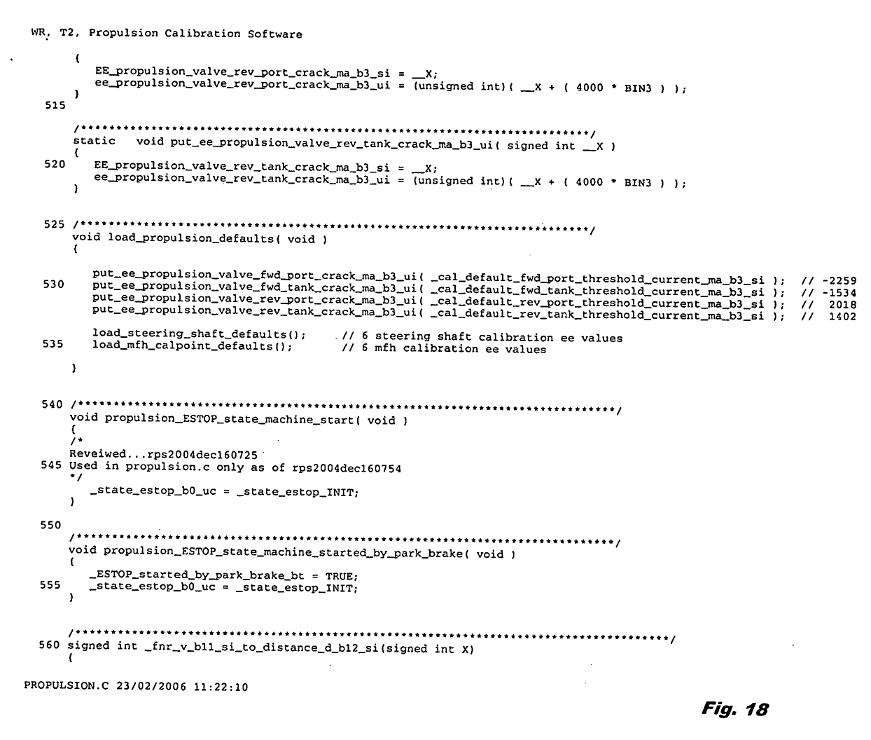

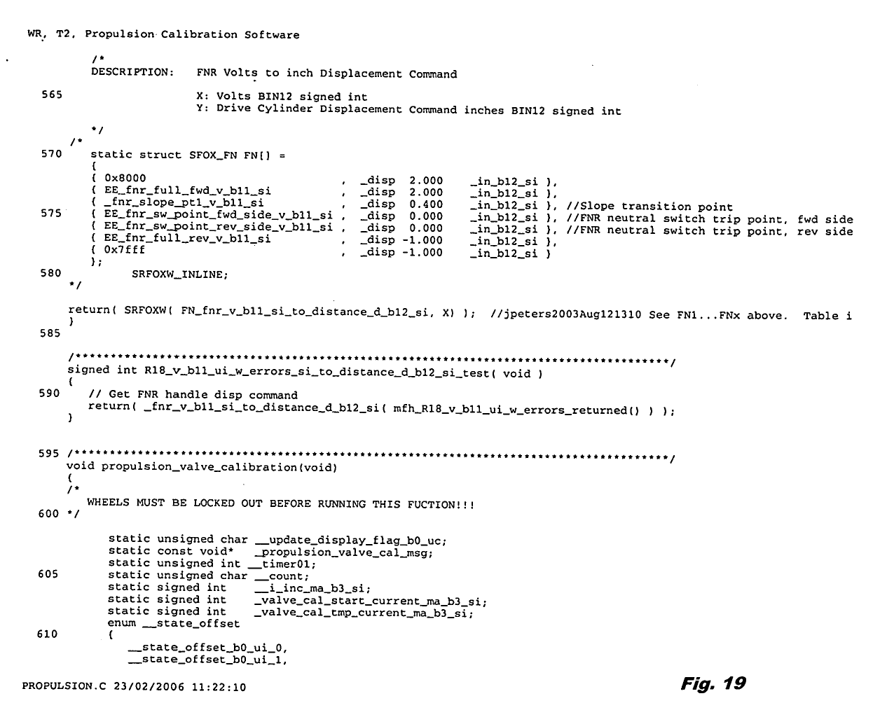

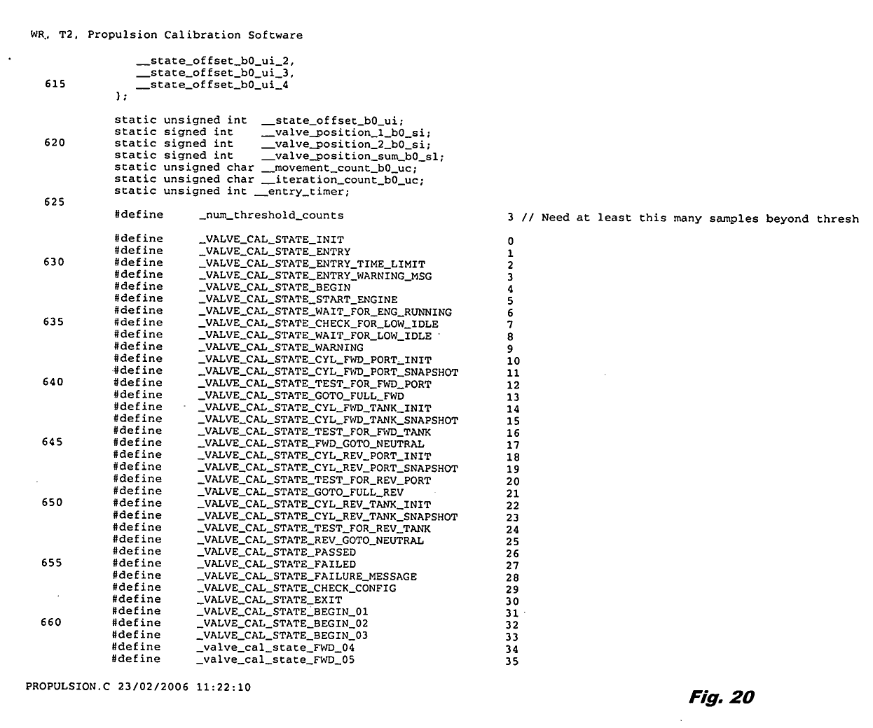

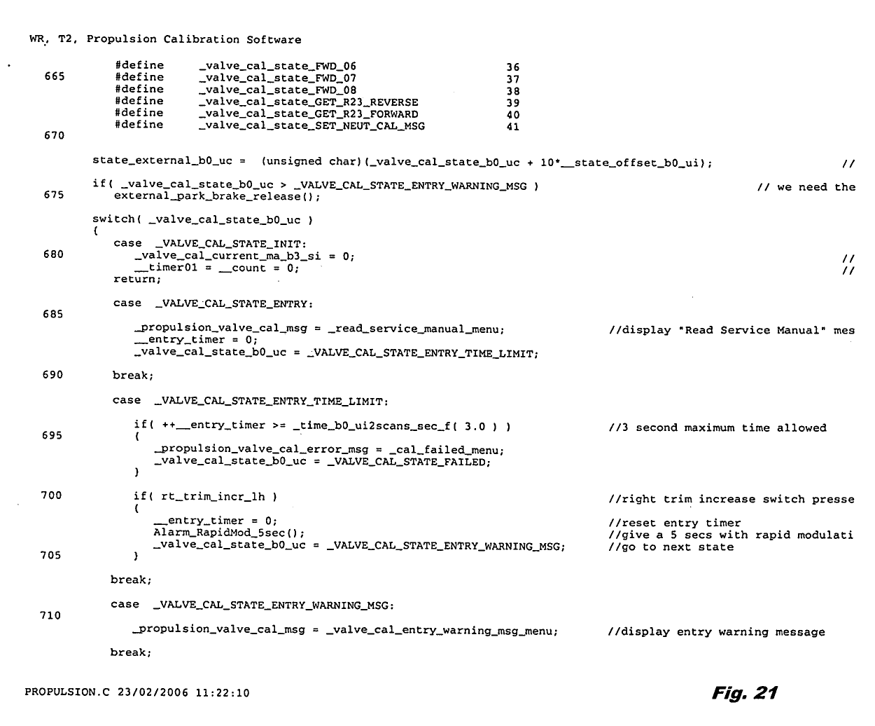

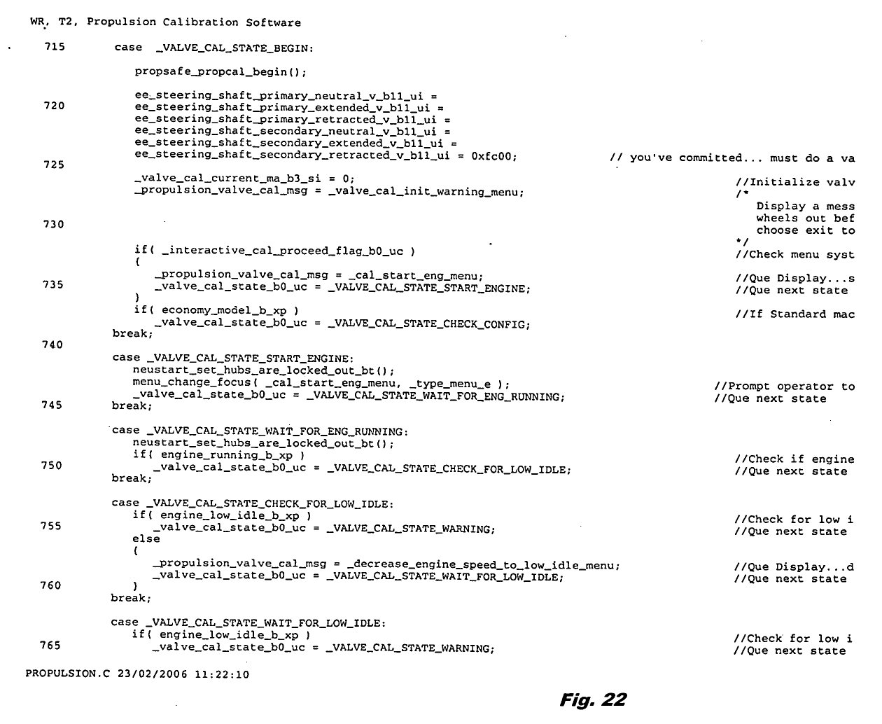

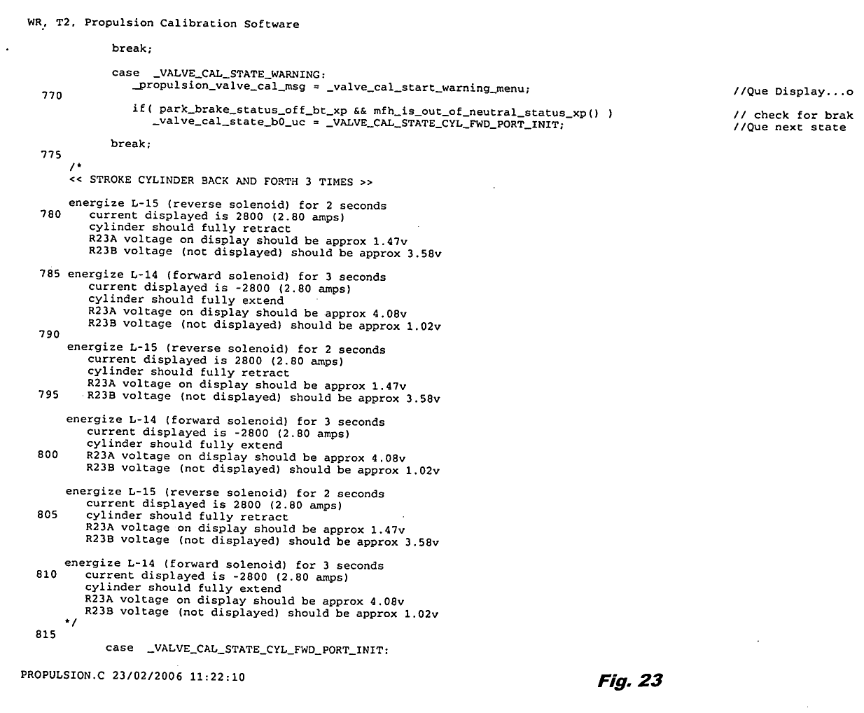

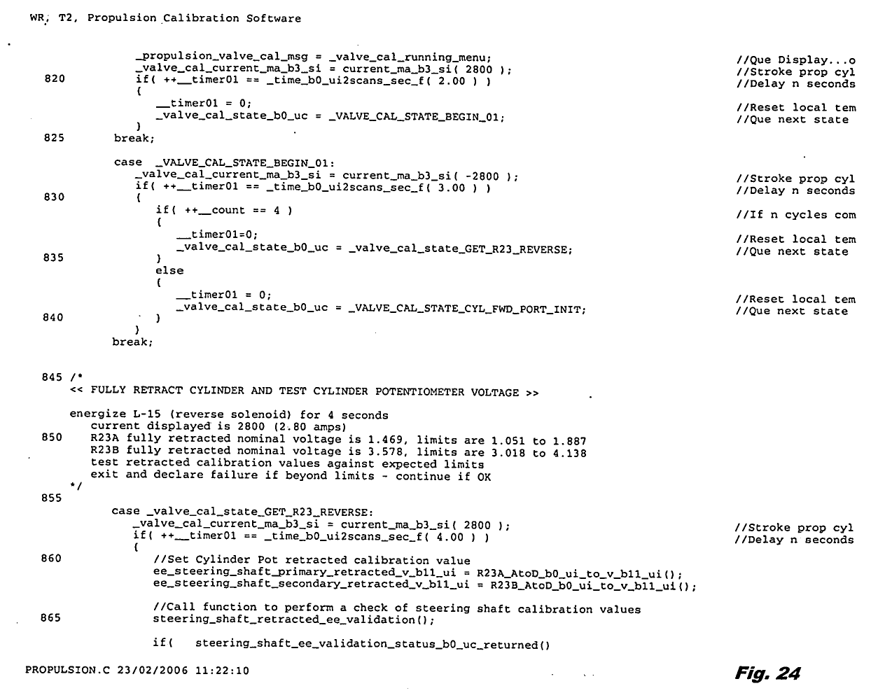

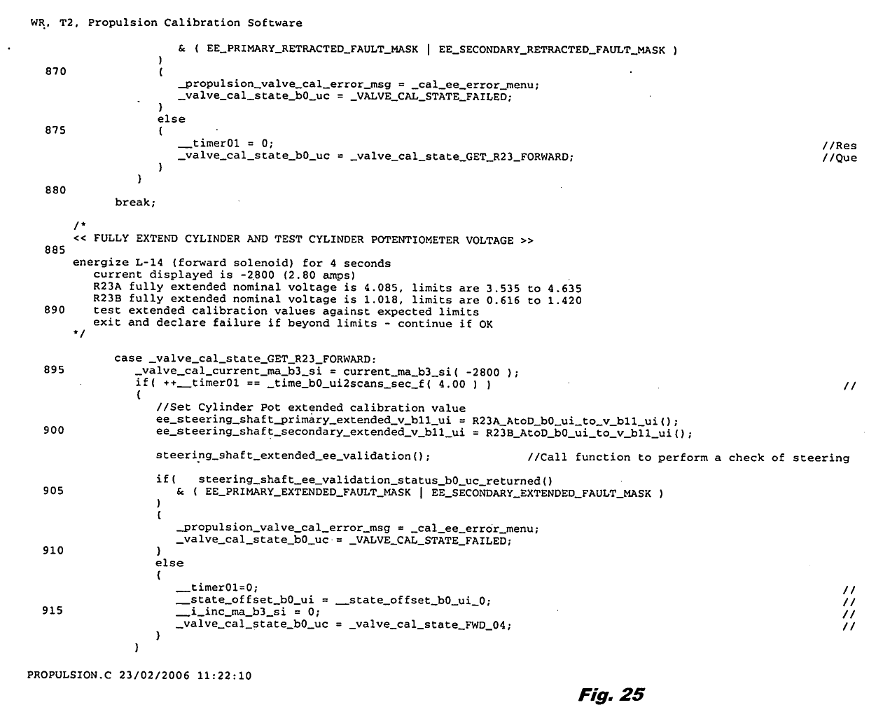

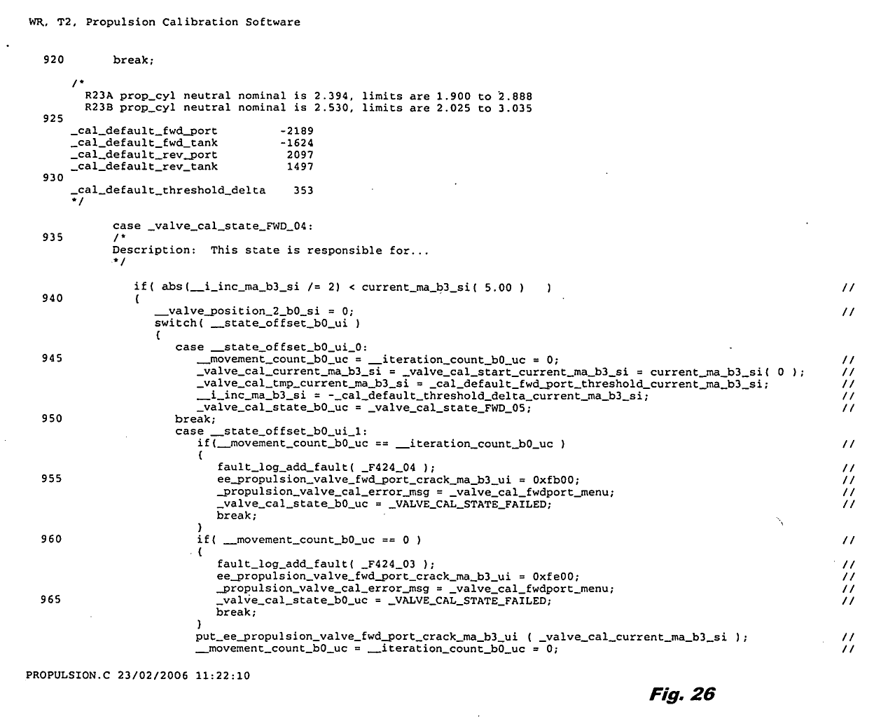

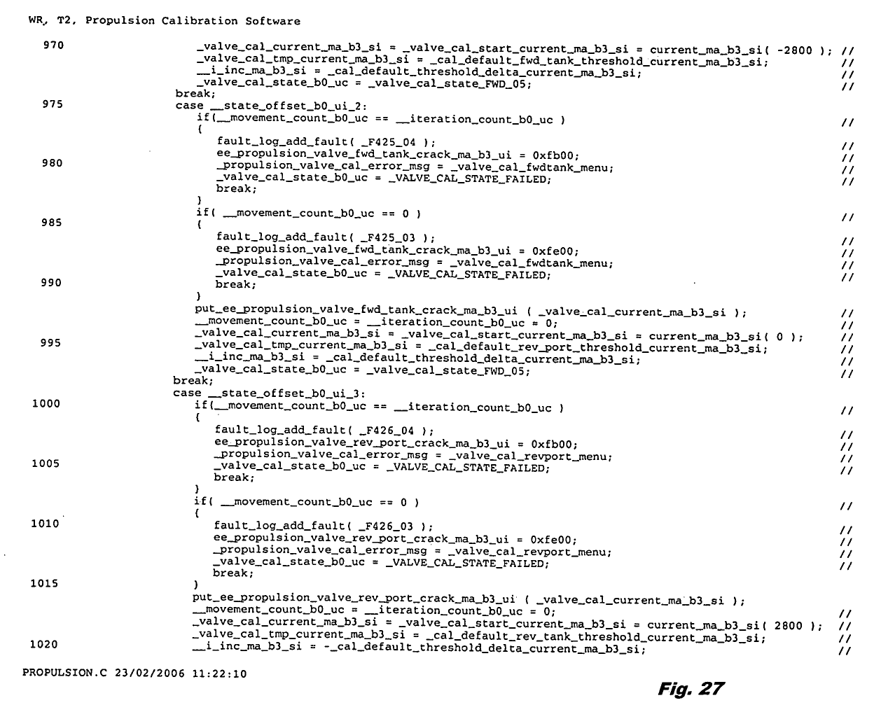

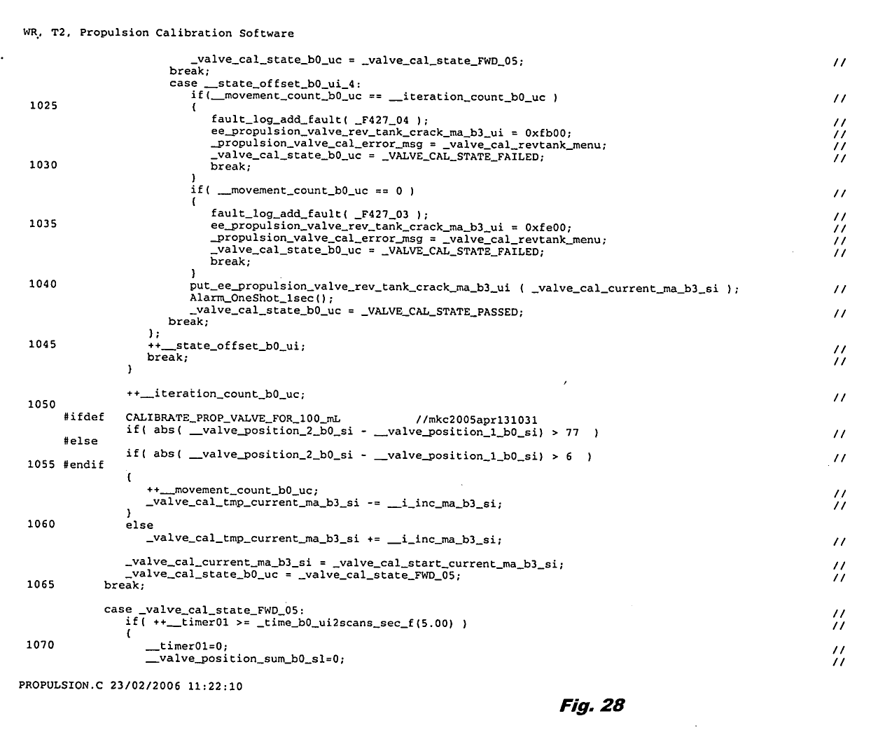

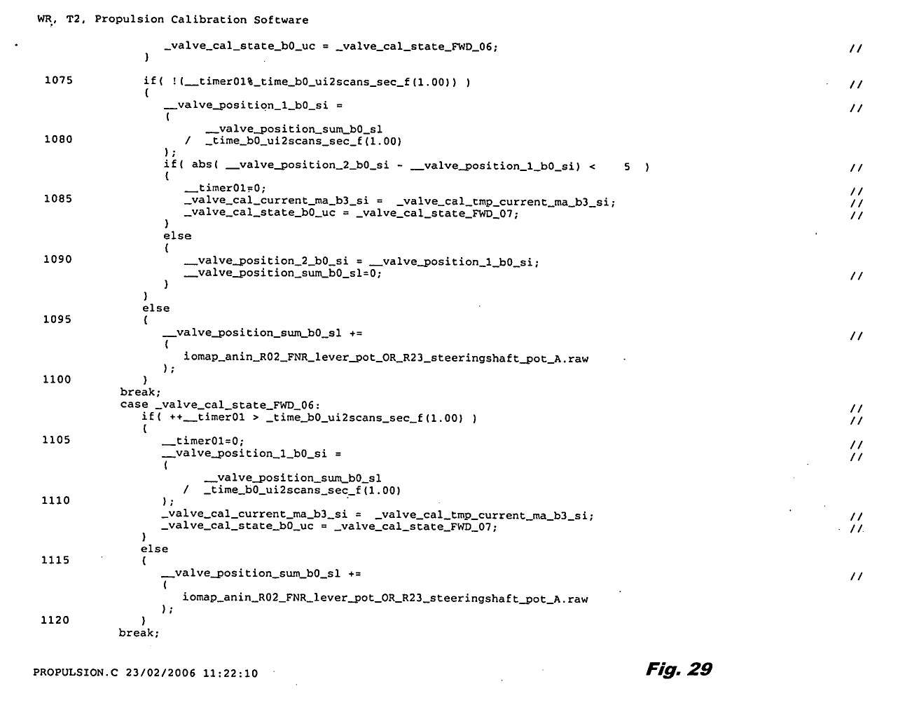

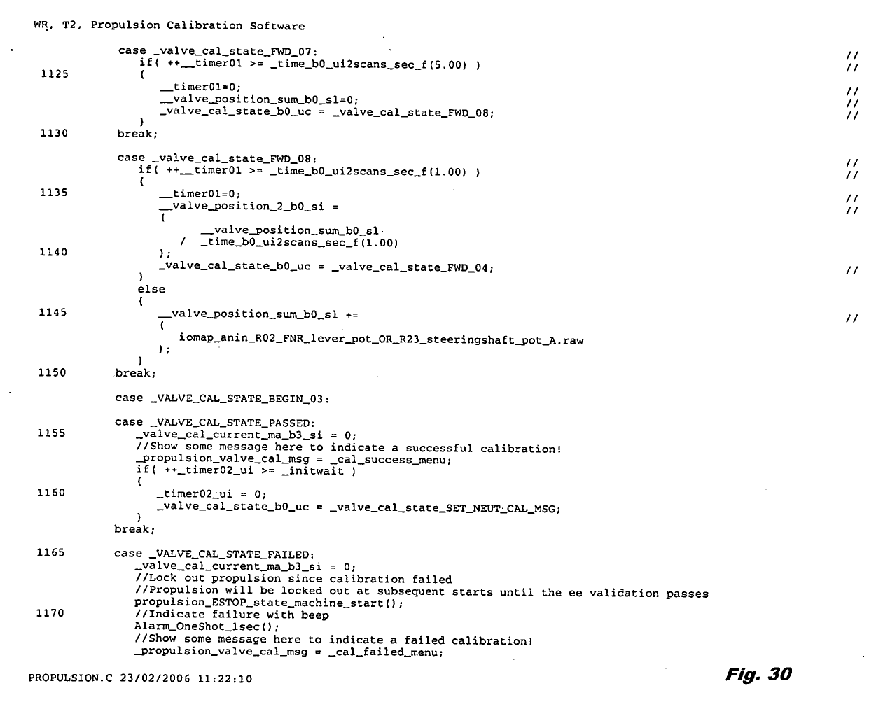

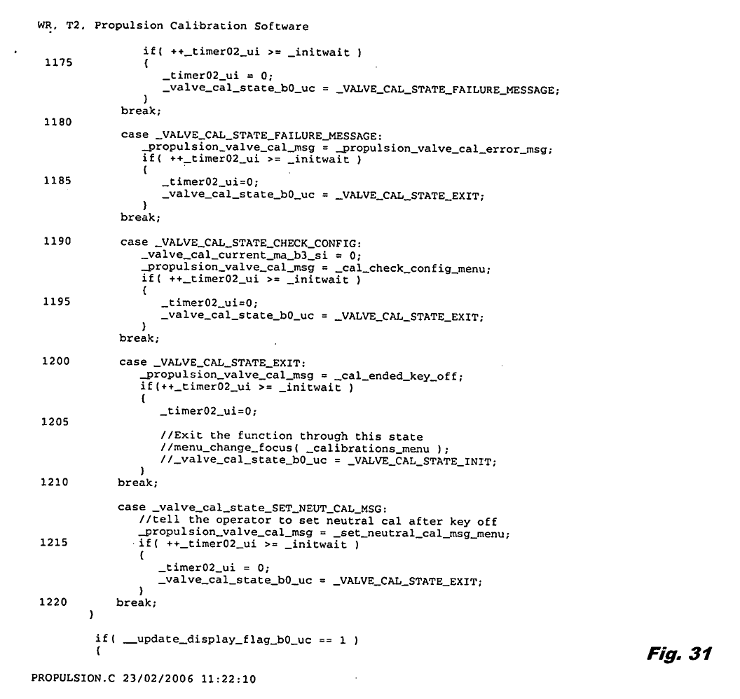

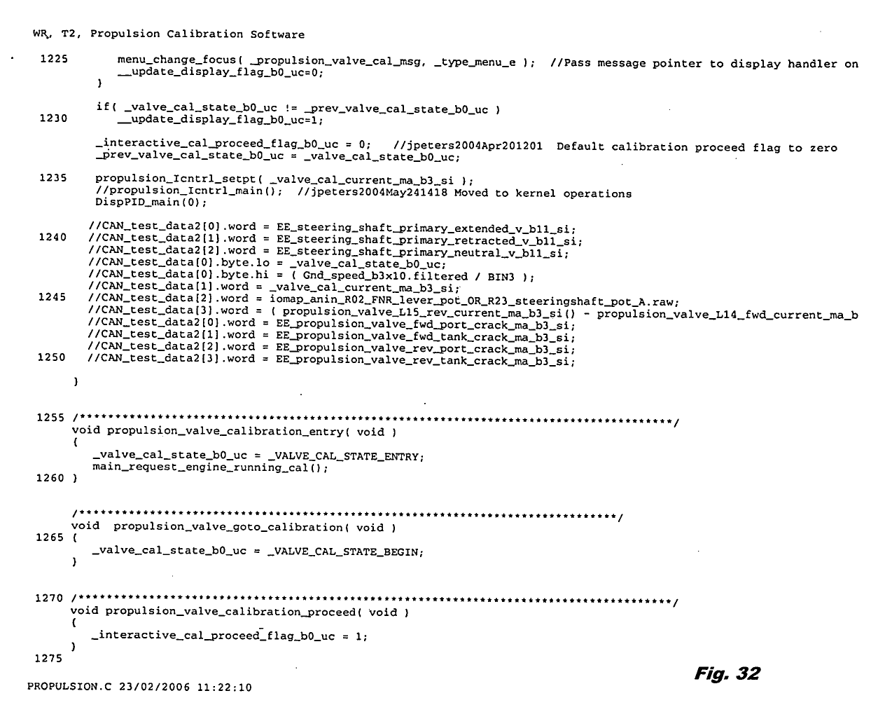

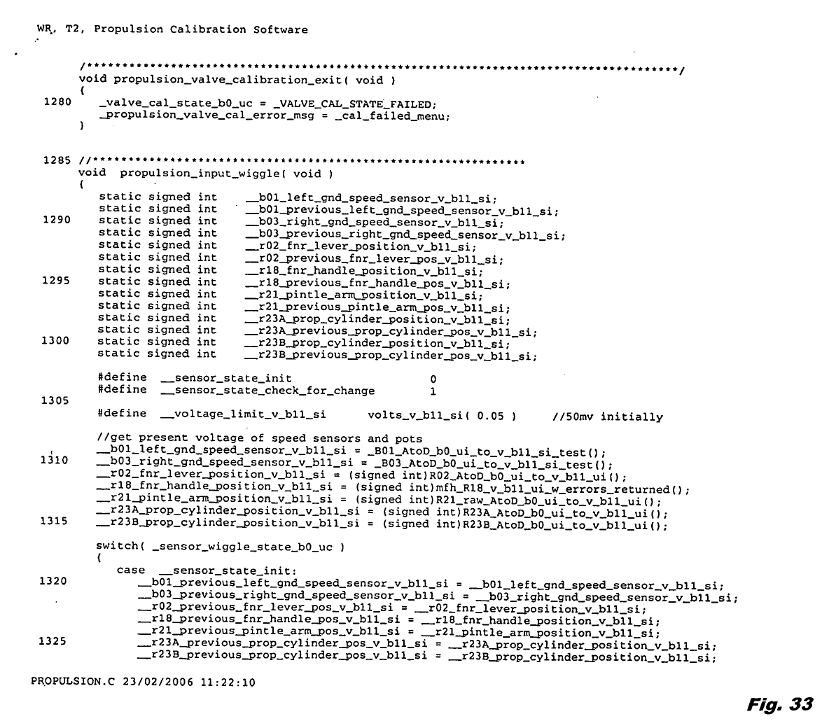

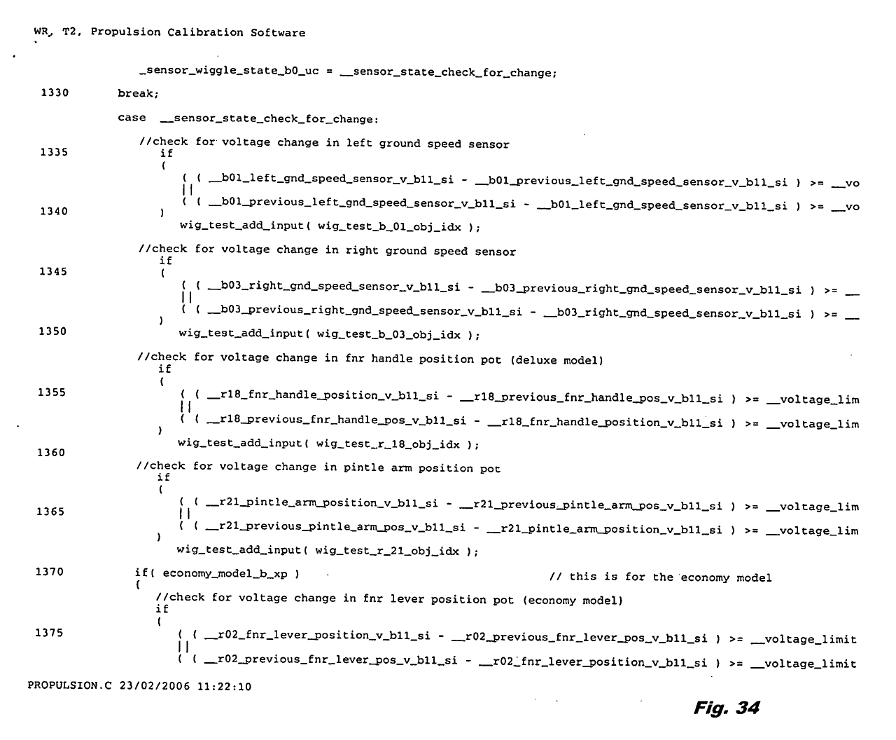

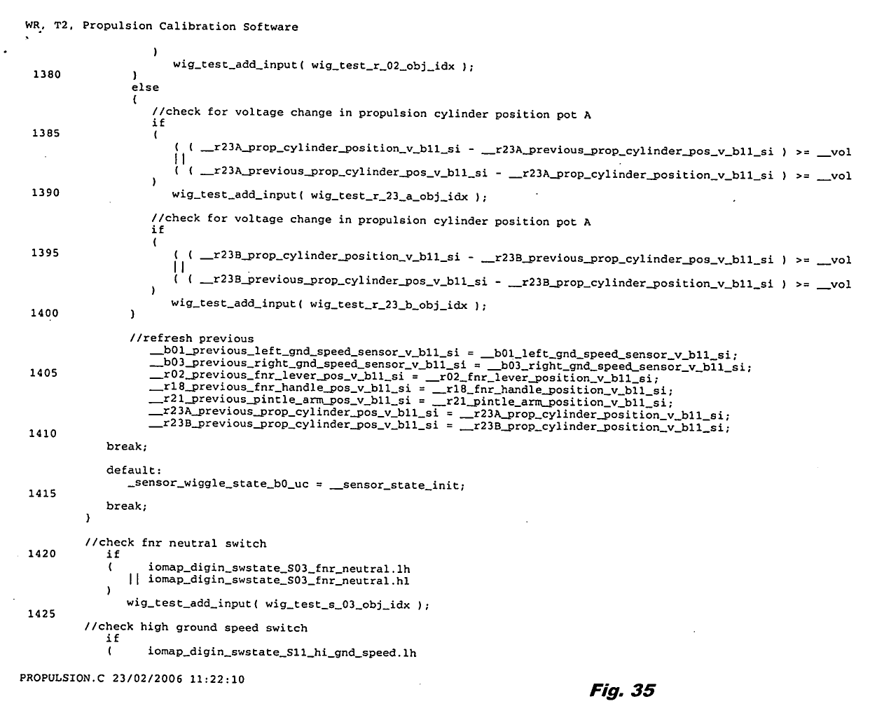

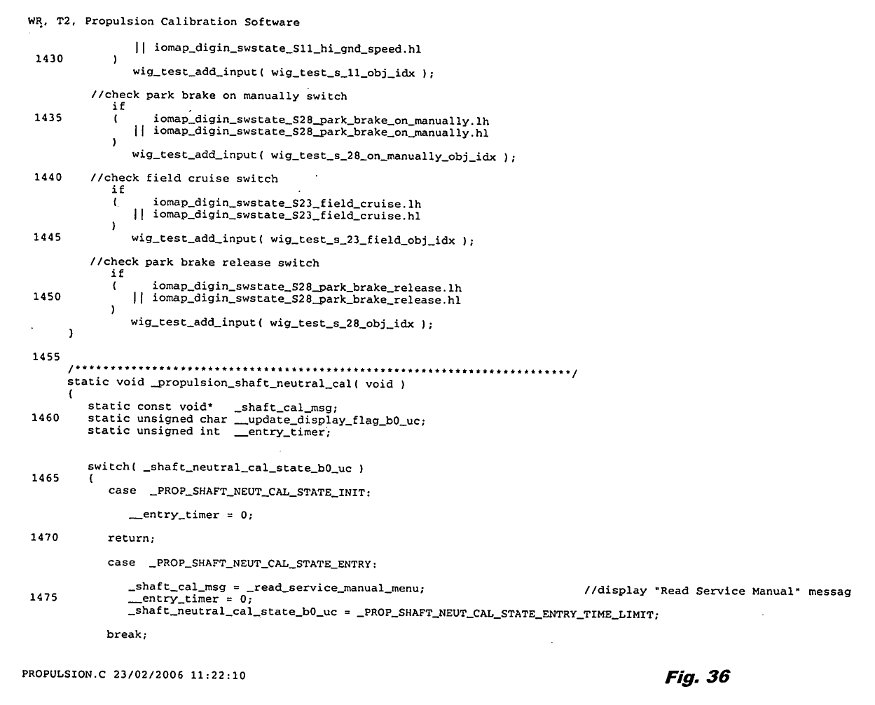

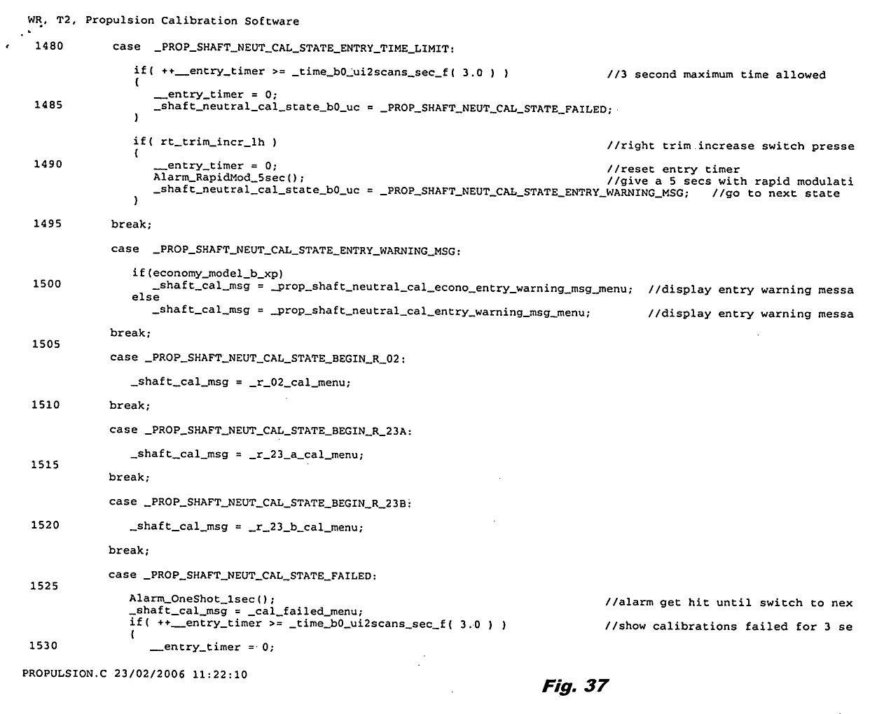

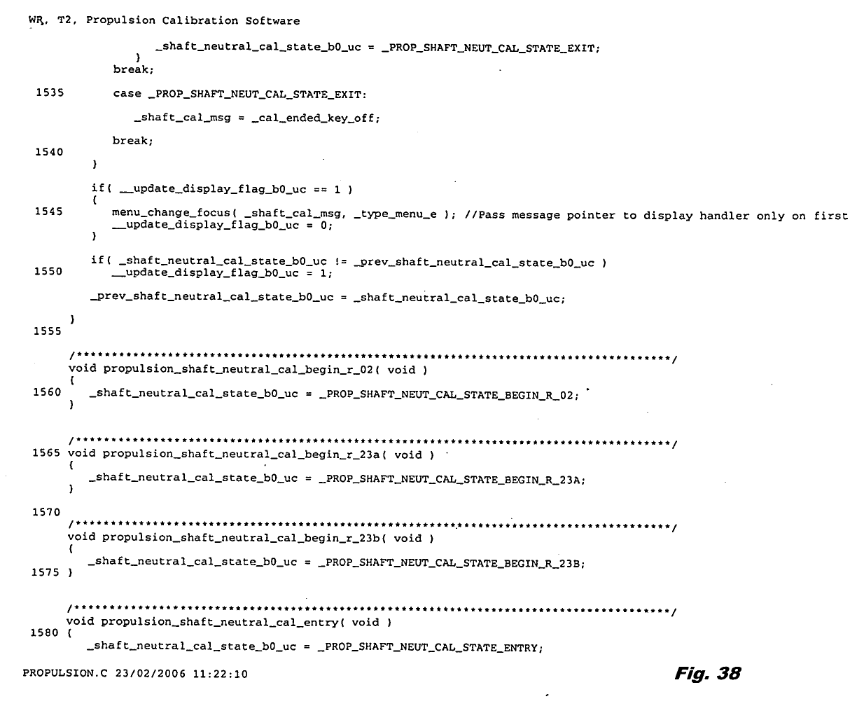

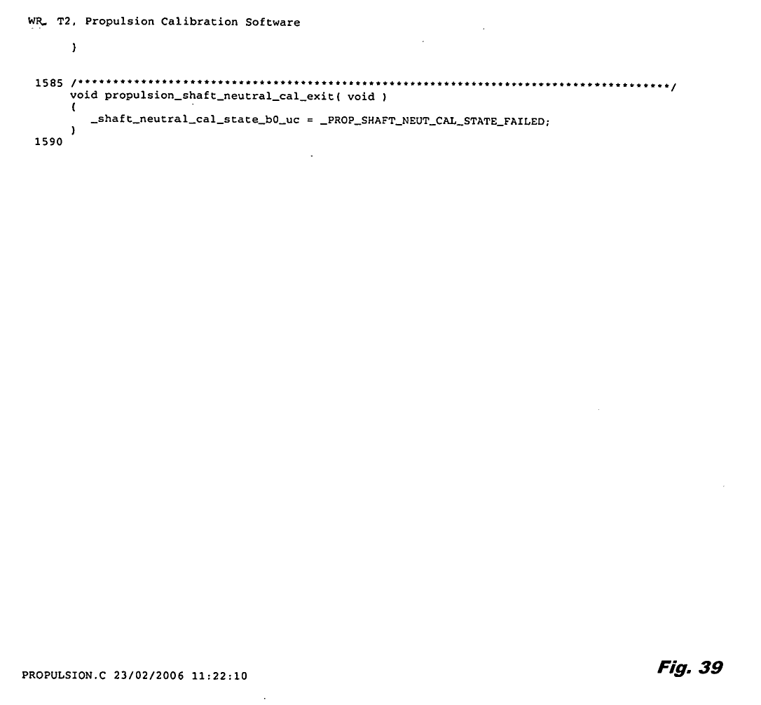

Referring also to FIGS. 8-39, lines of code of an actual computer program embodying the above described steps of the method of the invention is disclosed. The notes accompanying the lines of code describe many features of the method of the invention.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions. Accordingly, the following claims are intended to protect the invention broadly as well as in the specific form shown.

What is claimed is:

1. A method for calibrating a proportional solenoid valve operable for controlling a device for changing a displacement, comprising steps of:
providing a proportional solenoid controlled valve, the valve including a supply pressure port, at least one work port, and a tank port, the valve being controllably operable responsive to a control signal input for moving through a predetermined range of positions, including a range of positions wherein hydraulic fluid will be directed through the valve between at least the supply pressure port and the at least one work port;
providing a hydraulic cylinder in fluid communication with the at least one work port, the hydraulic cylinder being operable to move an element to various positions within a range of positions responsive to delivery of hydraulic fluid thereto from the at least one work port;
providing a sensor operable for detecting displacements of the element and outputting displacement signals including information representative of detected displacements;
providing a programmable control module in connection with the valve and the sensor, the control module being operable for outputting control signals to the valve and receiving the displacement signals from the sensor; and
wherein the control module is programmed for automatically calibrating the control signals, including steps of:
i. outputting a test control signal having a predetermined value to the valve for causing a predetermined displacement of the element, and comparing information representative of an actual displacement caused by the test control signal to information representative of the predetermined displacement;
ii. if the actual displacement is greater than the predetermined displacement, then incrementing a first counter and calculating a new test control signal as an average of the predetermined value of the test control signal and a first predetermined value; and
iii. if the actual displacement is less than the predetermined displacement, then incrementing a second counter and calculating a new test control signal as an average of the predetermined value of the test control signal and a second predetermined value, and
iv. repeating steps i through iii a predetermined number of times;
storing the value for the test control signal; and
operating the hydraulic cylinder using the stored value for determining displacements of the element.

2. The method of claim 1, wherein the control signal values comprise electrical currents.

3. The method of claim 1, wherein the predetermined displacement includes a tolerance range.

4. The method of claim 1, wherein when the actual displacement is less than the predetermined displacement, the new test control signal is calculated as an average of the test value and a historical high test value.

5. The method of claim 4, wherein the historical high test value is initialized to an upper control signal test limit and updated to the value of the test control signal when the actual displacement is greater than the predetermined displacement.

6. The method of claim 1, wherein when the actual displacement is greater than the predetermined displacement, the new test control signal is calculated as an average of the test value and a historical low test value.

7. The method of claim 6, wherein the historical low test value is initialized to a lower control signal test limit and updated to the value of the test control signal when the actual displacement is less than the predetermined displacement.

8. The method of claim 1, wherein the proportional solenoid valve is used in a propulsion system of an agricultural windrower.

9. The method of claim 1, wherein the information representative of the predetermined displacement is related to the position of the element that corresponds to an initiation of hydraulic fluid flow through the valve between the supply pressure port and the at least one work port.

10. The method of claim 1, wherein the information representative of the predetermined displacement is related to the position of the element that corresponds to an initiation of hydraulic fluid flow through the valve between the at least one work port and the tank port.
